(19) United States
(12) Patent Application Publication
(10) Pub. No.: US 2004/0182620 A1
(43) Pub. Date: Sep. 23, 2004

(54) Method and arrangement for limiting the speed of a vehicle

(75) Inventor: Michael Dornhausen, Markgroeningen (DE)

Correspondence Address: Walter Ottesen, Patent Attorney, P.O. Box 4026, Gaithersburg, MD, 20885-4026, US

(73) Assignee: Robert Bosch GmbH

(21) Appl. No.: 10/805,193

(22) Filed: Mar. 22, 2004

(30) Foreign Application Priority Data
Mar. 20, 2003 (DE) 103 12 386.5

(51) Int. Cl. B60K 31/00

(52) U.S. Cl. 180/170; 701/93

(57) ABSTRACT

A method and an arrangement make possible to limit the speed of a vehicle and to adapt to the environmental conditions. Environmental conditions of the vehicle are determined. A maximum permissible speed is determined in dependence upon the determined environmental conditions. The speed of the vehicle is limited to the maximum permissible speed.

### CROSS REFERENCE TO RELATED APPLICATION

This application claims priority of German patent application no. 103 12 386.5, filed Mar. 20, 2003, the entire content of which is incorporated herein by reference.

### BACKGROUND OF THE INVENTION

Methods for limiting the speed of a vehicle are known. Furthermore, it is known that modern vehicles are equipped with a sensor for detecting the moistening or wetting of the windshield with water. The window wipers are then driven in dependence upon the quantity of fluid.

The driver of the vehicle should adapt the speed when there is precipitation and a wet roadway associated therewith. This lies within the discretion and ability of the driver. Here, faulty estimates can be made with the corresponding high potential of danger for the driver and others.

### SUMMARY OF THE INVENTION

With respect to the above, the method of the invention and the arrangement of the invention afford the advantage that: the environmental conditions of the vehicle are determined; a permissible maximum speed is determined in dependence upon the determined environmental conditions; and, the speed of the vehicle is limited to the maximum permissible speed. In this way, a limiting of the speed can be realized in dependence upon the determined environmental conditions and the described potential for danger is reduced in that the maximum permissible speed of the vehicle is adapted to the environmental conditions.

It is especially advantageous when the environmental conditions are determined in dependence upon an intensity of precipitation, humidity, ambient temperature, ambient pressure and/or ambient brightness. In this way, essential environmental conditions for the determination of the maximum permissible speed are considered for the driving safety and the driving safety of the vehicle is thereby substantially ensured by limiting the speed to the maximum permissible speed.

A further advantage results when the limitation is disabled when an operator-controlled element (especially an accelerator pedal) is actuated beyond a pregiven threshold angle. In this way, the driver is not impaired by the speed limiting with respect to his freedom of decision as to the selection of the driving speed because the driver is informed as to the risk of exceeding the maximum permissible speed based on the speed limiting.

It is advantageous when the limiting is only disabled by an actuation of the operator-controlled element beyond the pregiven threshold angle when this actuation is present for at least a first pregiven time. In this way, it is ensured that the driver has noted the speed limiting because the vehicle does not react immediately to the corresponding actuation of the operator-controlled element. A similar effect could be realized by a pressure point of the operator-controlled element when reaching the pregiven threshold angle which threshold angle must be overcome to realize a vehicle speed going beyond the maximum permissible speed.

It is further advantageous when the limiting is disabled when at least one of the environmental conditions passes a pregiven threshold value. In this way, an unnecessary limiting of speed is prevented and the maximum possible speed range of the vehicle is offered to the driver in dependence upon the existing environmental conditions.

It is here advantageous that the limiting is disabled when: the rain intensity drops below a pregiven value; the ambient brightness exceeds a second pregiven value; the ambient temperature exceeds a third pregiven value; and/or, the ambient pressure exceeds a fourth pregiven value. In this way, it is ensured that the speed limiting is only disabled when the environmental conditions have improved and a reduction of the driving safety is no longer a consequence. A suitable selection for the pregiven values is decisive.

It is furthermore advantageous that the limiting is disabled when a switch-off condition is present. In this way, a limiting of speed, which is unnecessary with a view toward the driving safety, can likewise be avoided.

It is especially advantageous that a switch-off condition is present when the wheel slip of the vehicle drops below a fifth pregiven value and/or the instantaneous speed of the vehicle drops below a sixth pregiven value. In these cases, one cannot assume any danger to the driving safety for a suitable selection of the pregiven values and the speed limiting is therefore not required.

A further advantage is provided when the limiting only becomes active when the environmental conditions (which lead to the determination of the permissible maximum speed) are present uninterruptedly for a second pregiven time and the instantaneous speed of the vehicle exceeds the pregiven maximum speed. In this way, it is prevented that an only short-term impairment of the environmental conditions (which, with high probability, would not have as a consequence an impairment of the driving safety) does not lead immediately to a limiting of the speed of the vehicle and therewith to an unnecessary impairment of the driving comfort. The second pregiven time is likewise suitable and is selected to be not too long. The second time can, for example, be determined in driving experiments for short-term impairment of the environmental conditions.

It is furthermore advantageous when limiting the speed is realized by limiting a driver demand torque, engine torque, accelerating torque or limiting a degree of actuation of a driver-operated element, especially an accelerator pedal. In this way, the speed limiting can be realized especially easily.

A further advantage results when an increase of the speed of the vehicle above the maximum permissible speed is carried out in the form of a ramp function or iteratively in the form of a pregiven step width. In this way, it is prevented that the desired speed above the maximum permissible speed is reached too abruptly because of excessively depressing the accelerator pedal whereby the vehicle reaction remains controllable for the driver.

### BRIEF DESCRIPTION OF THE DRAWINGS

The invention will now be described with reference to the drawings wherein:

FIG. 1 is a block circuit diagram of an arrangement of the invention; and,

FIG. 2 is a flowchart showing the sequence of steps in the method of the invention.

### DESCRIPTION OF THE PREFERRED EMBODIMENTS OF THE INVENTION

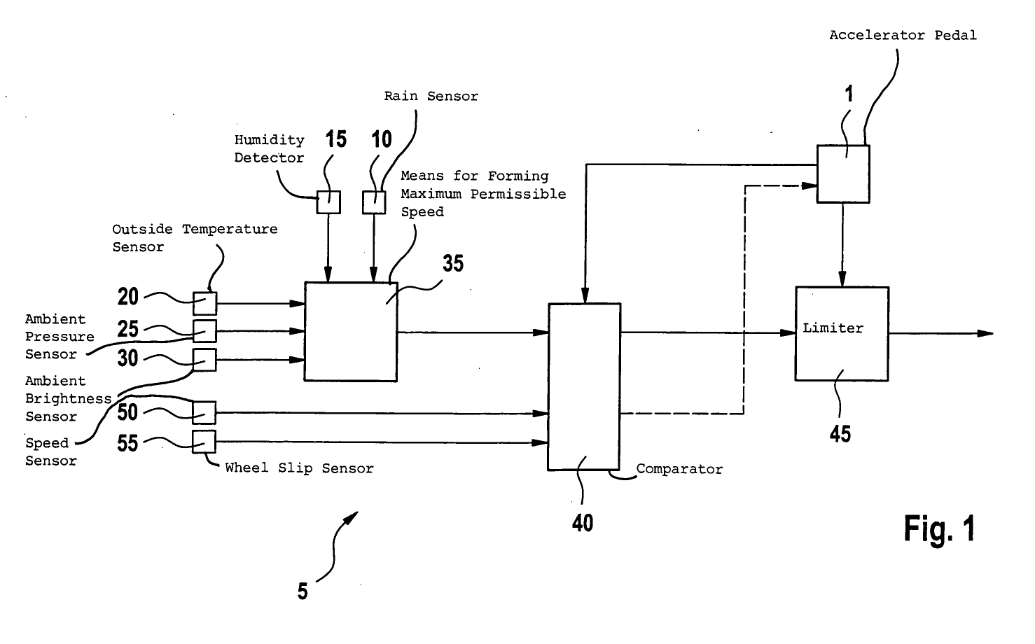

In FIG. 1, reference numeral 5 identifies an arrangement for limiting a speed of a vehicle. The vehicle can, for example, be configured as a motor vehicle having an internal combustion engine, an electric motor or a motor based on an alternative drive concept. The arrangement 5 includes means 35 for forming a maximum permissible speed. The means 35 are connected to first. detecting means 10 for detecting the rain intensity. The detecting means 10 can be a rain sensor which detects the wetting of the windshield by water and determines the rain intensity in dependence upon the detected liquid quantity on the windshield and transmits the same to means 35. In addition, or as an alternative, second detecting means 15 are provided which measure the humidity outside of the vehicle and conduct the same to the means 35. Additionally, or alternatively, third detection means 20 are provided which detect the ambient temperature outside of the motor vehicle and are, for example, configured as an outside thermometer. The third detecting means 20 conducts the measured ambient temperature to means 35. Additionally, or alternatively, fourth detecting means 25 are provided which detect the ambient pressure outside of the vehicle, for example, by means of a pressure sensor and conduct the same to the means 35. Additionally, or alternatively, fifth detecting means 30 are provided which measure the ambient brightness outside of the vehicle, for example, in the form of light intensity and conduct the same to the means 35. The fifth detecting means 30 can, for example, be a photosensor. The second detecting means 15 can, for example, be a hygrometer.

The means 35 include a characteristic field whose input quantities are the measured values, which are supplied by the detecting means, and which characteristic field forms a maximum permissible speed of the vehicle as an output quantity in dependence upon the received measured values. Here, it is necessary that at least one measured quantity for the environmental conditions of the vehicle is supplied to the means 35 and, in dependence upon this at least one measurement quantity, the maximum permissible speed is determined. This at least one measurement quantity can, for example, be the rain intensity measured by the first detecting means 10. It can, however, also be a measurement quantity of the remaining detecting means (15, 20 25, 30). Furthermore, several measurement quantities can be supplied to the characteristic field of the means 35 as input quantities. The more measurement quantities are supplied, the better are the environmental conditions considered in the formation of the maximum permissible speed. The characteristic field can, for example, be applied in the context of driving experiments of the vehicle for different environmental conditions. To different environmental conditions, that is, to different values of the measurement quantities utilized as input quantities, a corresponding maximum permissible speed of the vehicle is assigned in each case.

As a rule, individual measurement points for the measurement quantities used as input quantities are used in the application of the characteristic line. For this reason, measurement points, which are not considered for the application, can be interpolated to a corresponding maximum permissible speed in each case. The maximum permissible speed for the particular environmental condition should be so pregiven that the driving safety of the vehicle is ensured at this speed and for the corresponding environmental conditions. The maximum permissible speed is formed in the means 35 in dependence upon the environmental conditions of the vehicle and is supplied to comparator means 40. The comparator means 40 is furthermore connected to a speed sensor 50 for determining the instantaneous speed of the vehicle. In addition, the comparator means 40 can be optionally connected to a wheel slip sensor 55 which determines the wheel slip at one or several wheels of the vehicle. A degree of actuation of the operator-controlled element 1, for example, an accelerator pedal, is also supplied to the comparator means 40.

The degree of actuation can be supplied to the comparator means 40 as a pedal angle. The comparator means 40 compares the instantaneous speed of the vehicle to the maximum permissible speed and outputs a maximum permissible driver command torque to the limiting means 45 when the instantaneous speed of the vehicle exceeds a maximum permissible speed. The maximum permissible torque is assigned to the maximum permissible speed, for example, in the context of a speed control. Otherwise, the comparator means 40 outputs no torque limiting to the limiting means 45. Furthermore, a driver command torque, which corresponds to the pedal angle, is supplied from the accelerator pedal 1 to the limiting means 45. The limiting means 45 is configured as a minimum selection member and selects a minimum of two input quantities as an output quantity so that, in the case of the input of the maximum permissible driver command torque, the output quantity of the limiting means 45 is limited to this maximum permissible driver command torque or is less than this maximum permissible driver command torque. For the case that the comparator means 40 outputs no torque limiting, the output of the limiting means 45 corresponds to the driver command torque, which is supplied by the accelerator pedal 1, so that no limiting is present.

Additionally, or alternatively, it can be provided that the comparator means 40 outputs a maximum permissible pedal angle, for example, likewise in the context of a speed control for the accelerator pedal 1 which effects a limiting to the maximum permissible speed when the instantaneous speed exceeds the maximum permissible speed. Otherwise, the comparator means 40 outputs no limiting of the pedal angle.

The limiting of the pedal angle takes place in accordance with the connection shown in phantom outline between the comparator means 40 and the accelerator pedal 1.

When a pedal angle of the accelerator pedal 1 is assigned to the maximum permissible speed (which, in the following, is also characterized as a pregiven threshold angle and is assigned to the maximum permissible driver command torque), it can be provided in accordance with the invention that, when reaching this pregiven threshold angle, a pressure is formed which acts against the actuation of the driver and advises the driver as to reaching the speed limiting. If the driver nonetheless has the wish to move the vehicle with a higher speed than the maximum permissible speed, then the driver can do this by an actuation of the accelerator pedal beyond the pregiven threshold angle and by overcoming the effective counterforce at the accelerator pedal 1. In this way, the limiting of the speed is overcome or disabled.

In addition, or alternatively, it can be provided that the disablement of the speed limiting via the described excessive depression of the accelerator pedal beyond the pregiven threshold angle takes place only when this excessive depression is present for at least a first pregiven time. In this way, it is ensured that the driver actually wants to disable the existing speed limiting. In case no counterpressure is built up at the accelerator pedal when reaching the pregiven threshold angle, the driver can also recognize the existing speed limiting in that, when exceeding the pregiven threshold angle, the vehicle will at first not react, instead, the vehicle will react only after the elapse of a first pregiven time. The first pregiven time is to be selected sufficiently long so that the driver associates the delayed reaction of the vehicle actually to an active speed limiting and not, for example, to an inertial effect, for example, because of the intake manifold dynamic. The first pregiven time should therefore be suitably applied and should, in any event, be greater than the maximum occurring delay time for the realization of the driver command torque. The first pregiven time should also not be selected too long in order to not unnecessarily delay a safety-critical acceleration operation of the vehicle beyond the speed limiting.

Additionally, or alternatively, the speed limiting can also be disabled when at least one of the environmental conditions passes a pregiven threshold value. The limiting can, for example, be disabled when the rain intensity, which is detected by the first detecting means 10, falls below a first pregiven value. This comparison can take place in means 35. If it is determined there that the rain intensity has dropped below the first pregiven value, then the input of the maximum permissible speed and therefore the speed limiting is disabled.

Additionally, or alternatively, the means 35 can disable the limiting in a corresponding manner when the ambient brightness, which is determined by the fifth detecting means 30, exceeds a second pregiven value. Additionally, or alternatively, the means 35 can disable the speed limiting in a corresponding manner when the outside temperature, which is determined by the third detecting means 20, exceeds a third pregiven value. Additionally, or alternatively, the means 35 can disable the speed limiting in a corresponding manner when the ambient pressure, which is determined by the fourth detecting means 25, exceeds a fourth pregiven value. The means 35 can disable the limiting when only one of the above-mentioned environmental conditions passes the corresponding pregiven threshold value in the manner described. A higher driving safety is, however, obtained when the means 35 only disables the limiting when all detected environmental conditions pass the corresponding pregiven threshold values in the manner described. The pregiven values can be applied in a suitable manner, for example, based on driving experiments and be so fixed that, when they are reached, endangerment of the driving safety because of an unlimited driving speed is not to be expected. The disablement of the speed limiting based on improved environmental conditions, as described, can take place independently of the disablement of the speed limiting based on an excessive depression of the accelerator pedal.

Additionally, it can be provided that the disablement of the speed limiting of the vehicle can only take place based on the improved environmental conditions when these environmental conditions pass the corresponding pregiven threshold value for at least a third pregiven time in the manner described. In this way, a certain hysteresis is realized and a continuous activation and deactivation of the speed limiting of the vehicle in a region of the environmental conditions close to the particular pregiven threshold value is prevented.

Additionally, or alternatively, it can be provided that the limiting is disabled when a switch-off condition is present. A switch-off condition is, for example, present when the wheel slip of the vehicle drops below a fifth pregiven value. The wheel slip is detected by the wheel slip sensor 55. A single wheel slip sensor for one of the wheels of the vehicle can be provided. Alternatively, a wheel slip sensor can be provided for each wheel of the vehicle. In this case, the switch-off condition is present when the wheel slip for each wheel drops below the fifth pregiven value. In this case, a danger to the driving safety is not to be feared and the speed limiting can be deactivated.

Additionally, or alternatively, a switch-off condition can also be present when the instantaneous speed of the vehicle, which is detected by the speed sensor 50, has dropped below a sixth pregiven value. In this case too, one need not assume a danger to the driving safety at the instantaneous speed of the vehicle so that the limiting of the speed can be disabled. The fifth pregiven value and the sixth pregiven value can, for example, likewise be applied in the context of driving experiments. When these values are set as low as possible, then the probability of an impairment of the driving safety can be estimated to be low.

As shown in FIG. 1, the wheel slip sensor 55 and the speed sensor 50 are coupled to the comparator means 40. The switch-off conditions are therefore checked by the comparator means 40. The fifth pregiven value and the sixth pregiven value can be stored in the comparator means 40 whereas the first pregiven value, the second pregiven value, the third pregiven value and the fourth pregiven value can be stored in the means 35. The disablement of the limiting of the speed by the comparator means 40 takes place in that the input of the maximum permissible driver command torque to the limiting means 45 is disabled. Correspondingly, the comparator means 40 disables also the limiting of the pedal angle of the accelerator pedal 1, for example, by removing the pressure buildup at the pregiven threshold angle or by annulling the first pregiven time for overcoming the speed limiting for a corresponding actuation of the accelerator pedal 1.

For activating the speed limiting, it can be provided that the environmental conditions of the vehicle, which lead to the determination of the maximum permissible speed, must be uninterruptedly present for a second pregiven time so that the limiting can be activated. In this way, a hysteresis function is realized which prevents that a short-term deterioration of the environmental conditions, which would lead to the formation of the maximum permissible speed, does not yet have as a consequence a speed limiting so that a continuous activation and deactivation of the speed limiting is prevented in a boundary region of the environmental conditions, for example, in the region of the pregiven threshold value. It can be provided that the means 35 determines the maximum permissible speed when the rain intensity exceeds the first pregiven value and/or the ambient brightness drops below the second pregiven value and/or the outside temperature drops below the third pregiven value and/or the ambient pressure drops below the fourth pregiven value. This means that the maximum permissible speed is determined in a first embodiment when one of the detected environmental conditions passes the assigned pregiven threshold value in the manner described. In an alternate embodiment, which imposes lesser requirements on driving safety, it can be provided that, for determining the maximum permissible speed, all detected environmental conditions must pass the correspondingly assigned threshold value in the manner described.

It can be further provided that the speed limiting by the comparator means 40 is only activated by the formation of the maximum permissible driver command torque and/or by limiting the pedal angle to the pregiven threshold angle after determining the maximum permissible speed when also the instantaneous speed of the vehicle, which is determined by the speed sensor, exceeds the maximum permissible speed supplied to the comparator means 40, provided the environmental conditions have not improved in the manner described so that an existing speed limiting would be disabled.

For the case wherein the means 35 have determined the maximum permissible speed based on corresponding poor environmental conditions as described but the driver does not want a limiting of the speed and shows this via actuation of the accelerator pedal 1 for the first pregiven time, the limiting is disabled and an increase of the speed can be realized in the form of a ramp function or iteratively in a pregiven step width. This affords the advantage that an abrupt approximation to the speed, which is wanted by the driver, is avoided and the driving comfort and driving safety are not impaired thereby. The increase of the speed in the form of a ramp function can, for example, take place in accordance with a linear characteristic line stored in the comparator means 40. This characteristic line limits the increase of the driver command torque and inputs this limited slope to the limiting means 45 which then limits the increase of the speed of the vehicle to this limit value in accordance with the pregiven ramp function. The pregiven ramp function can likewise be suitably applied, for example, in the context of driving experiments in order to ensure the desired driving comfort and the desired driving safety. In the case of an increase of the speed of the vehicle, the initial speed is increased up to the speed wanted by the driver above the maximum permissible speed with the aid of the iterative method in a pregiven step width. In each iterative step, the increase takes place in accordance with the pregiven step width, which likewise (for example, in driving experiments) can be applied in such a manner that a wanted driving comfort and a wanted driving safety are maintained. The smaller the step width and the less steep the slope of the ramp function, the greater are the driving comfort and the driving safety for the increase of the speed. The greater the pregiven step width or the slope of the ramp function, the more rapid the speed is reached which is wanted by the driver. For the pregiven step width or the slope of the ramp function, values can also be pregiven in dependence upon the type of driver, for example, for a sporty driver type a greater pregiven step width or a greater slope of the ramp function and for a more economical driver type, for example, a lower step width or a less steep slope of the ramp function is provided. In the case of the iterative increase of the speed in the pregiven step width, the comparator means 40 can output a correspondingly incremented driver command torque to the limiting means 40 for each iterative step to which the driver command torque in the particular iterative step is limited. This driver command torque is wanted by the driver via the actuation of the accelerator pedal 1.

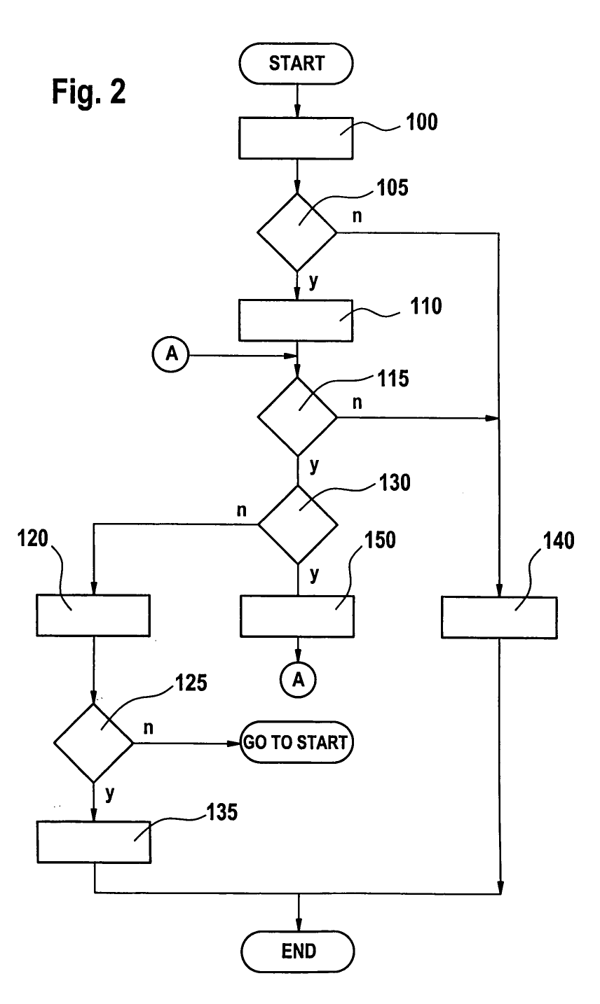

In FIG. 2, a flowchart for an exemplary sequence of the method of the invention is shown. After the start of the program, at program point 100, the means 35 detects the measurement quantities detected by the detecting means (10, 15, 20, 25, 30). Thereafter, the program branches to program point 105.

At program point 105, the means 35 checks whether one of the detected measurement quantities passes the assigned threshold value in a direction toward poorer environmental conditions, that is, the rain intensity exceeds the first pregiven value or the ambient brightness drops below the second pregiven value or the ambient pressure drops below the fourth pregiven value or the humidity exceeds a seventh pregiven value. If this is the case uninterruptedly for more than the second pregiven time, then the program branches to program point 110; otherwise, the program branches to program point 140.

At program point 110, the means 35 determines the maximum permissible speed assigned to the detected measurement quantities in accordance with the characteristic field. Thereafter, the program branches to program point 115.

At program point 115, the comparator means 40 detects whether the instantaneous speed of the vehicle exceeds the maximum permissible speed. If this is the case, then the program branches to program point 130; otherwise, the program branches to program point 140.

At program point 130, the comparator means 40 checks whether the accelerator pedal is depressed beyond the pregiven threshold angle for at least the first pregiven time. If this is the case, then the program branches to program point 150; otherwise, the program branches to program point 120.

At program point 120, the comparator means 40 initiates the formation of a maximum permissible driver command torque, which corresponds to the maximum permissible speed and outputs this to the limiting means 45. Additionally, or alternatively, the comparator means 40 can limit the pedal angle to the pregiven threshold angle in the manner described with this threshold angle corresponding to the maximum permissible speed.

The assignment of the maximum permissible driver command torque, which is formed in the comparator means 40, to the maximum permissible speed or the assignment of the pregiven threshold angle for the accelerator pedal 1 to the maximum permissible speed takes place, for example, in the context of a speed control or alternatively in each case with the aid of a characteristic field, which can be applied on a test stand and/or in driving experiments in different operating conditions and/or driving situations.

Thereafter, the program branches to program point 125. At program point 125, the means 35 checks whether all detected environmental conditions have passed the particular assigned threshold value in the manner described toward better environmental or ambient conditions for at least the second pregiven time. If this is the case, then the program branches to program point 135; otherwise, the program branches to the start of the program and the program is run through anew. Additionally, or alternatively, the comparator means 40 can check at program point 135 whether one of the described switch-off conditions is present for at least a fourth pregiven time. If this is the case, independently of the check as to the environmental conditions, then the program branches to program point 135; otherwise, the program branches to the start and the program is run through anew. The fourth pregiven time can, for example, correspond to the second pregiven time or can be suitably applied in driving experiments in such a manner that an only short-term presence of a switch-off condition (for example, because of a disturbance in the measurement value detection) does not lead immediately to the disablement of the speed limiting and a certain hysteresis function is realized which prevents the continuous activation and deactivation of the speed limiting.

At program point 135, the comparator means 40 disables the speed limiting in the case of the presence of one of the switch-off conditions or for depressing the accelerator pedal 1 too far or the means 35 disables the speed limiting in the case of the improvement of the environmental conditions. Thereafter, there is a movement out of the program. At program point 140, the driver command torque, which is requested by the driver at the accelerator pedal 1, is realized as rapidly as possible without limiting. Thereafter, there is a movement out of the program

At program point 150, the comparator means 40 raises the input for the driver command torque starting from the torque assigned to the instantaneous speed in accordance with the pregiven ramp function or in accordance with an iterative step in the amount of the pregiven step width. The increase according to the ramp function can take place completely at program point 150; whereas, in the case of the iterative increase in accordance with the pregiven step width, at program point 150 either a single iterative step or all iterative steps are carried out until reaching the speed wanted by the driver and the driver command torque coupled thereto. After program point 150, the program branches back to program point 115. The interrelationship between the instantaneous speed and the assigned torque can likewise take place in the comparator means 40 based on the already described speed control or characteristic line which assigns the maximum permissible driver command torque to the maximum permissible speed.

By limiting to a speed adapted to the environmental conditions of the vehicle, it is made possible for the driver to adapt his driving to these environmental conditions. At the same time, the risk of aquaplaning of the vehicle on a rain-wet roadway as well as skidding of the vehicle is reduced and a possibly effective dynamic driving control is supported.

The sequence plan of FIG. 2 can be run through repeatedly during a driving cycle in an advantageous manner. The function of the speed limiting described by way of example in accordance with the sequence plan of FIG. 2 can, for example, be activated or deactivated by a switch. The sequence plan of FIG. 2 is then only run through with an activated function.

Via the ambient temperature and the ambient pressure, a weather model can be considered for the consideration of environmental or ambient conditions of the vehicle for speed limiting. The weather model is defined by the ambient temperature and the ambient pressure.

If the instantaneous speed exceeds the maximum permissible speed in the case of the activated limiting function, for example, according to FIG. 2, then the comparator means 40 can output a torque for the limiting means 45 for a short time which is less than the maximum permissible driver command torque or is even zero in order to limit the instantaneous speed as rapidly as possible to the maximum permissible speed.

Via the limiting activated at program point 120, the driver can, for example, be informed by a lamp on the instrument panel of the vehicle. The means 35, the comparator means 40 and the limiting means 45 can be arranged in a control apparatus of the vehicle. The detected measurement quantities of the detecting means (10, 15, 20, 25, 30) can be transmitted to the control apparatus and to the means 35 via suitable data lines. The control apparatus can be the engine control apparatus. If the control apparatus is, however, different from the engine control apparatus of the vehicle, then the limiting, which is carried out by the limiting means 45, must, in turn, be transmitted to the engine control via a suitable data line and be realized there. In the described example, it was assumed that the accelerator pedal 1 determines the driver command torque and transmits the same to the limiting means 45. Alternatively, the accelerator pedal 1 can also detect only the accelerator pedal angle and transmit the same to the limiting means 45 in the same way as to the comparator means 40. In the limiting means 45, the accelerator pedal angle is converted into the driver command torque.

The accelerator pedal angle is converted into the driver command torque with the aid of a characteristic field. This characteristic field can be applied on a test stand.

Alternatively to limiting the speed to the maximum permissible speed by limiting the driver command torque to the maximum permissible driver command torque, the limiting of the speed to the maximum permissible speed can also be achieved by limiting the engine rpm, the engine power, the cylinder charge or the like to a corresponding pregiven value in accordance with the speed control or in a characteristic field in association with the maximum permissible speed. Such a characteristic field can likewise be applied on a test stand. The accelerator pedal angle is then likewise formed, for example, with the aid of the speed control or a suitable characteristic field matched to the assigned rpm, cylinder charge or motor power and is supplied to the limiting means 45 from the accelerator pedal 1 or is there determined based on the accelerator pedal angle.

The corresponding characteristic field can be applied on a test stand.

Everywhere where, in the above description, quantities are coupled to each other via a characteristic field, a mathematical relationship can be used for such a coupling in lieu of the characteristic field if such a mathematical relationship can be formed or when such a mathematical relationship at least approximately describes a determined characteristic field course or characteristic line course.

Alternatively to the described characteristic field controlled limiting of the speed to the maximum permissible speed, the speed of the vehicle can also be limited by means of a control to the maximum permissible speed without it being necessary to determine the following: a maximum permissible driver command torque, a pregiven threshold angle for the accelerator pedal 1, a maximum permissible engine rpm, engine power, cylinder charge or the like.

It is understood that the foregoing description is that of the preferred embodiments of the invention and that various changes and modifications may be made thereto without departing from the spirit and scope of the invention as defined in the appended claims.

What is claimed is:

1. A method of limiting the speed of a vehicle, the method comprising the steps of:
determining the environmental conditions of said vehicle;
determining a maximum permissible speed in dependence upon the determined environmental conditions; and,
limiting the speed of said vehicle to said maximum permissible speed.

2. The method of claim 1, comprising the further step of determining said environmental conditions in dependence upon at least one of the following: rain intensity, humidity, ambient temperature, ambient pressure and ambient brightness.

3. The method of claim 1, comprising the further step of disabling said limiting when an operator-controlled element is actuated beyond a pregiven threshold angle.

4. The method of claim 1, wherein said operator-controlled element is an accelerator pedal.

5. The method of claim 3, wherein said limiting is disabled when the actuation of said operator-controlled element beyond said pregiven threshold has been present for at least a first pregiven time.

6. The method of claim 1, comprising the further step of disabling said limiting when at least one of said environmental conditions passes a pregiven threshold.

7. The method of claim 6, wherein said limiting is disabled when at least one of the following occurs: the rain intensity drops below a first pregiven value; the ambient brightness exceeds a second pregiven value; the ambient temperature exceeds a third pregiven value and the ambient pressure exceeds a fourth pregiven value.

8. The method of claim 1, comprising the further step of disabling the limiting when a switch-off condition is present.

9. The method of claim 8, wherein said switch-off condition is present when at least one of the following occurs: the wheel slip of said vehicle drops below a fifth pregiven value and the instantaneous speed of said vehicle drops below a sixth pregiven value.

10. The method of claim 5, wherein said limiting only becomes active when the environmental conditions, which lead to the determination of the maximum permissible speed, are present uninterrupted for a second pregiven time and the instantaneous speed of said vehicle exceeds the maximum permissible speed.

11. The method of claim 1, wherein said limiting of the speed is realized by limiting a driver command torque or is realized by limiting a degree of actuation of an operator-controlled element.

12. The method of claim 11, wherein said operator-controlled element is an accelerator pedal.

13. The method of claim 1, wherein an increase of the speed of said vehicle above the maximum permissible speed is carried out in the form of a ramp function or iteratively in a pregiven step width.

14. Arrangement for limiting the speed of a vehicle, the arrangement including:
means for determining the environmental conditions of said vehicle;
means for determining a maximum permissible speed in dependence upon the determined environmental conditions; and,
means for limiting the speed of said vehicle to said maximum permissible speed.
